(19) United States
(12) Patent Application Publication
(10) Pub. No.: US 2022/0405501 A1
(43) Pub. Date: Dec. 22, 2022

(54) Systems and Methods to Automatically Determine Human-Object Interactions in Images

(71) Applicant: HUAWEI TECHNOLOGIES CO., LTD., SHENZHEN (CN)

(72) Inventors: Tahmid Zubayer CHOWDHURY, Surrey (CA); Kevin James CANNONS, Vancouver (CA); Zhan XU, Richmond (CA)

(73) Assignee: HUAWEI TECHNOLOGIES CO., LTD., SHENZHEN (CN)

(21) Appl. No.: 17/352,022

(22) Filed: Jun. 18, 2021

(51) Int. Cl. G06K 9/00; G06K 9/46; G06T 7/73; G06N 3/08

(52) U.S. Cl. CPC G06K 9/00335; G06K 9/46; G06K 9/00362; G06T 7/73; G06N 3/08; G06T 2207/20084; G06T 2207/30196

(57) ABSTRACT

Methods and systems for determining human-object interactions (HOIs) in images are provided. The method includes receiving an image. The method further includes detecting at least one human in the image, and at least one object in the image. The method further includes creating one or more proposals, wherein each proposal includes a human of the at least one human and an object of the at least one object. The method further includes determining whether an HOI exist in each of the one or more proposals. In some embodiments, the method further includes generating a mask for each proposal of the one or more proposals in which an HOI is determined to exist, the mask generated based on the determined HOI. In some embodiment, the HOI determination is based on one or more of extracted human feature information, extracted object appearance feature information, and extracted spatial feature information.

### CROSS-REFERENCE TO RELATED APPLICATIONS

This is the first application filed for the present invention.

### FIELD OF THE INVENTION

The present invention pertains to the field of image detections, and in particular to systems and methods to automatically determine human-object interactions in images.

BACKGROUND

Demand for image editing applications has been continuously increasing in social media and smartphones, among others. Image editing may rely on effective detection of human-object interaction (HOI) in the image. However, exiting HOI detection techniques may suffer from limitations that make image-editing impractical to deploy in real-world applications. Some limitations may include: poor detection of HOI generally; poor detection of HOI where the object is far from the human; inability to filter noise and contradictory information leading to poor detection of HOI; and inability to differentiate interacting and non-interacting human-object pairs.

Therefore, there is a need for systems and methods to automatically determine human-object interactions in images that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An aspect of the disclosure provides for a method for detecting human-object interaction (HOI) in an image. The method includes receiving the image. The method further includes detecting at least one human in the image. The method further includes detecting at least one object in the image. The method further includes creating one or more proposals, each of the one or more proposals including a human of the at least one human and an object of the at least one object. The method further includes determining whether an HOI exists in each of the one or more proposals. Embodiments may provide for an improved detection of HOI in an image.

In some embodiments, the method further includes generating a mask for each proposal of the one or more proposals in which an HOI is determined to exist, the mask generated based on the determined HOI. Embodiments may provide for a more accurate segmentation mask.

In some embodiment, the determining whether an HOI exist in each of the one or more proposals includes extracting human feature information from the one or more proposals. In some embodiment, the determining whether an HOI exist in each of the one or more proposals further includes extracting object appearance feature information from the one or more proposals. In some embodiment, the determining whether an HOI exists in each of the one or more proposals further includes determining whether an HOI exist between the human and the object based at least in part on the human feature information and the object feature information. Embodiments may provide for improved detection of HOI.

In some embodiments, the method further includes extracting spatial feature information from the one or more proposals, the spatial feature information related to the human and the object. In some embodiments the HOI determination is further based on the spatial feature information. In some embodiments, the method further includes editing the image based on the generated mask. Embodiments may provide for enhanced image editing capabilities. Embodiments may further provide filtering of objects interacting with humans in an image.

Another aspect of the disclosure provides for a method for determining a human-object interaction (HOI) from a proposal. The method includes receiving the proposal including a human and an object, the proposal created based on an image. The method further includes extracting human feature information from the proposal. The method further includes extracting object appearance feature information from the proposal. The method further includes extracting spatial feature information from a human-object crop determined according to boundaries of the human and the object in the image. The method further includes determining whether an HOI exists between the human and the object based on the human feature information, the object feature information, and the spatial feature information. Embodiments may provide for an improved detection of HOI in an image.

In some embodiments, the extracting human feature information from the proposal includes extracting human pose feature information from a human-crop, the human-crop determined according to boundaries of the human in the image. In some embodiments, the extracting human feature information from the proposal includes extracting human appearance feature information from the human-crop.

In some embodiments the extracting object appearance feature information from the proposal includes extracting the object appearance feature information from an object-crop determined according to boundaries of the object in the image.

In some embodiments, the determining includes applying multiplicative operation to the human pose feature information and the human appearance feature information to generate a first pose-based human appearance feature output. In some embodiments, the determining further includes applying, via a first neural network, non-linear transformation to the first pose-based human appearance feature output to generate a second pose-based human appearance feature output. In some embodiments, the determining further includes applying, via a second neural network, non-linear transformation to the human appearance feature information to generate human appearance output. In some embodiments, the determining further includes concatenating the second pose-based human appearance feature output with the human appearance output to generate a third pose-based human appearance feature output. In some embodiments, the determining further includes applying, via a third neural network, non-linear transformation to the third pose-based human appearance feature output to generate a fourth pose-based human appearance feature output. Embodiments may provide for improved estimation of human action using human pose information via conditioning human appearance features on human pose features.

In some embodiments, the method further includes applying multiplicative operation to the human pose feature information and the spatial feature information to generate a first pose-aware spatial feature output. In some embodiments, the method further includes applying, via a fourth neural network, non-linear transformation to the first pose-aware spatial feature output to generate a second pose-aware spatial feature output. In some embodiments, the method further includes concatenating the second pose-aware spatial feature output with the spatial feature information to generate a third pose-aware spatial feature output. In some embodiments, the method further includes applying, via a fifth neural network, non-linear transformation to the third pose-aware spatial feature output to generate a fourth pose-aware spatial feature output. Embodiments may provide for improved spatial representation of human an object in an image via conditioning relation network's output with huma pose information.

In some embodiments, the method further includes generating a first human local context output based on concatenation of the fourth pose-based human appearance feature output and the fourth pose-aware spatial feature output. In some embodiments, the method further includes applying, via a sixth neural network, non-linear transformation to the first human local context output to generate a second human local context output. In some embodiments, the method further includes generating a first human-object global context output based on concatenation of: the fourth pose-based human appearance feature output, the fourth pose-aware spatial feature output, and the object appearance feature information. In some embodiments, the method further includes applying, via a seventh neural network, non-linear transformation to the first human-object global context output to generate a second human-object global context output. In some embodiments, the method further includes generating a first object local context output based on concatenation of the fourth pose-aware spatial feature output and the object appearance feature information. In some embodiments, the method further includes applying, via an eighth neural network, non-linear transformation to the first object local context output to generate a second object local context output. Embodiments may provide for improved context representation that jointly considers local and global context of the human, the object and the human-object together as described herein.

In some embodiments, the method further includes generating a context aware multi-feature output based on concatenation of: the second human local context output, the second human-object global context output and the second object local context output. In some embodiments, the method further includes applying, via a ninth neural network, non-linear transformation to the context aware multi-feature output to generate an indication of the HOI.

In some embodiments, the first, the second, the third, the fourth, the fifth, the sixth, the seventh, and the eighth neural networks are shallow fully connected neural networks. In some embodiments, the ninth neural network is a dense neural network including output nodes equal to a number of HOI classes.

In some embodiments, the method further includes applying, via a tenth neural network, non-linear transformation to the fourth pose-based human appearance feature output to generate a fifth pose-based human feature output. In some embodiment, the method further includes applying via an eleventh neural network, non-linear transformation to the object appearance feature information to generate a first object appearance feature output. In some embodiments, the context aware multi-feature output is based on concatenation of the second human local context output, the first human-object global context output, the first object local context output, the fifth pose-based human feature output, and the first object appearance feature output.

Another aspect of the disclosure provides for a human-object interaction (HOI) system. The system includes a pose detector, a human feature extractor, an object feature extractor, a relation network, and an HOI contextual and reasoning module. The pose detector configured for receiving a human-crop determined according to boundaries of a human in a human-object proposal. The pose detector further configured for extracting human pose feature information from the human-crop. The pose detector further configured for sending the human pose feature information to the HOI contextual and reasoning module. The human feature extractor configured for receiving the human-crop. The human feature extractor further configured for extracting human appearance feature information from the human-crop. The human feature extractor further configured for sending the human appearance feature information to the HOI contextual and reasoning module. The object feature extractor configured for receiving an object-crop determined according to boundaries of an object in the human-object proposal. The object feature extractor further configured for extracting object appearance feature information from the object-crop. The object feature extractor further configured for sending the object appearance feature information to the HOI contextual and reasoning module. The relation network configured for receiving a human-object crop determined according to boundaries of the human and the object. The relation network further configured for extracting spatial feature information from the human-object crop. The relation network further configured for sending the spatial feature information to the HOI contextual and reasoning module. The HOI contextual and reasoning module configured for receiving the human pose feature information, the human appearance feature information, the object appearance feature information, and the spatial feature information. The HOI contextual and reasoning module further configured for determining whether an HOI exists between the human and the object based on received information. Embodiments may provide for an improved detection of HOI in an image.

In some embodiments the HOI contextual and reasoning module includes a pose-based human-appearance feature module configured for applying a multiplicative operation to the human pose feature information and the human appearance feature information to generate a first pose-based human appearance feature output. In some embodiments, the pose-based human-appearance feature module is further configured for applying, via a first neural network, non-linear transformation to the first pose-based human appearance feature output to generate a second pose-based human appearance feature output. In some embodiments, the pose-based human-appearance feature module is further configured for applying, via a second neural network, non-linear transformation to the human appearance feature information to generate human appearance output. In some embodiments, the pose-based human-appearance feature module is further configured for concatenating the second pose-based human appearance feature output with the human appearance output to generate a third pose-based human appearance feature output. In some embodiments, the pose-based human-appearance feature module is further configured for applying, via a third neural network, non-linear transformation to the third pose-based human appearance feature output to generate a fourth pose-based human appearance feature output. Embodiments may provide for improved estimation of human action using human pose information via conditioning human appearance features on human pose features.

In some embodiments the HOI contextual and reasoning module further includes a pose-aware spatial encoding module configured for applying a multiplicative operation to the human pose feature information and the spatial feature information to generate a first pose-aware spatial feature output. In some embodiments, the pose-aware spatial encoding module is further configured for applying, via a fourth neural network, non-linear transformation to the first pose-aware spatial feature output to generate a second pose-aware spatial feature output. In some embodiments, the pose-aware spatial encoding module is further configured for concatenating the second pose-aware spatial feature output with the spatial feature information to generate a third pose-aware spatial feature output. In some embodiments, the pose-aware spatial encoding module is further configured for applying, via a fifth neural network, non-linear transformation to the third pose-aware spatial feature output to generate a fourth pose-aware spatial feature output. Embodiments may provide for improved spatial representation of human an object in an image via conditioning relation network's output with huma pose information.

In some embodiments, the HOI contextual and reasoning module further includes a context-aware multi-feature embedding module configured for generating a first human local context output based on concatenation of the fourth pose-based human appearance feature output and the fourth pose-aware spatial feature output. In some embodiments, the context-aware multi-feature embedding module is further configured for applying, via a sixth neural network, non-linear transformation to the first human local context output to generate a second human local context output. In some embodiments, the context-aware multi-feature embedding module is further configured for generating a first human-object global context output based on concatenation of: the fourth pose-based human appearance feature output, the fourth pose-aware spatial feature output, and the object appearance feature information. In some embodiments, the context-aware multi-feature embedding module is further configured for applying, via a seventh neural network, non-linear transformation to the first human-object global context output to generate a second human-object global context output. In some embodiments, the context-aware multi-feature embedding module is further configured for generating a first object local context output based on concatenation of the fourth pose-aware spatial feature output and the object appearance feature information. In some embodiments, the context-aware multi-feature embedding module is further configured for applying, via an eight neural network, non-linear transformation to the first object local context output to generate a second object local context output. In some embodiments, the context-aware multi-feature embedding module is further configured for generating a context aware multi-feature output based on concatenation of: the second human local context output, the second human-object global context output and the second object local context output. In some embodiments, the context-aware multi-feature embedding module is further configured for applying, via a ninth neural network, non-linear transformation to the context aware multi-feature output to generate an indication of the HOI. Embodiments may provide for improved context representation that jointly considers local and global context of the human, the object and the human-object together as described herein.

In some embodiments, the first, the second, the third, the fourth, the fifth, the sixth, the seventh, and the eighth neural networks are shallow fully connected neural networks. In some embodiments, the ninth neural network is a dense neural network including output nodes equal to a number of HOI classes.

In some embodiments, the context-aware multi-feature embedding module is further configured for applying, via a tenth neural network, non-linear transformation to the fourth pose-based human appearance feature output to generate a fifth pose-based human feature output. In some embodiment, the context-aware multi-feature embedding module is further configured for applying via an eleventh neural network, non-linear transformation to the object appearance feature information to generate a first object appearance feature output. In some embodiments, the context aware multi-feature output is based on concatenation of the second human local context output, the first human-object global context output, the first object local context output, the fifth pose-based human feature output, and the first object appearance feature output.

Other aspects of the disclosure provide for apparatus, and systems configured to implement the methods disclosed herein. For example, a device can be configured with machine readable memory containing instructions, which when executed by the processors of these devices, configures the device to perform the methods disclosed herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a pipeline, according to an embodiment of the present disclosure.

FIG. 2A-2D are visual illustrations of the pipeline in FIG. 1, according to an embodiment of the present disclosure.

FIG. 3A illustrates examples applications of the pipeline of FIG. 1, according to an embodiment of the present disclosure.

FIG. 3B illustrates further example applications of the pipeline of FIG. 1, according to an embodiment of the present disclosure.

FIG. 3C illustrates yet further example applications of the pipeline of FIG. 1, according to an embodiment of the present disclosure.

FIG. 4 illustrates an HOI network, according to an embodiment of the present disclosure.

FIG. 5 illustrates pose-based human appearance feature module of the HOI network of FIG. 4, according to an embodiment of the present disclosure.

FIG. 6 illustrates pose-aware spatial encoding module of the HOI network of FIG. 4, according to an embodiment of the present disclosure

FIG. 7 illustrates context-aware multi-feature embedding module of the HOI network of FIG. 4, according to an embodiment of the present disclosure

FIG. 8 illustrates a device that may perform any or all of operations of the methods and features explicitly or implicitly described herein, according to different embodiments of the present disclosure.

It will be noted that throughout the appended drawings, like features are identified by like reference numerals.

### DETAILED DESCRIPTION

Embodiments may provide for a system to automatically identify human-object interactions in an image. Embodiments may further provide for an automatic pipeline that utilizes HOIs to filter and retain the objects associated with the person of interest. Embodiments of the automatic pipeline may be used in various applications as described herein.

The person of interest may refer to the main person in an image, which may be selected either by a user or through a main-person detecting algorithm. As may be appreciated by a person skilled in the art, determination of HOI or lack thereof in an image may provide useful information that may be outputted for further processing, based on one or more applications.

Current state-of-the-art HOI networks suffer from limitations that may make it impractical to deploy in real-world applications as further described herein.

Further, image-editing applications have attracted demands in social media and smartphones, among others. However, these applications, such as bokeh mode, artificial intelligence (AI) colour, and inpainting, may be unable to automatically identify an object associated with the person in an image. For example, an image of a person holding a tennis racket, the AI colour algorithm may only identify the person but not the tennis racket.

As may be appreciated by a person skilled in art, most existing HOI detection techniques may comprise two parts, namely, object localization and interaction classification. With respect to object localization, off-the-shelf object detectors (e.g., Faster R-CNN and Mask R-CNN) may be used to detect humans and objects to create human-object proposals.

With respect to interaction classification, the human-object proposals may be sent to a multi-stream network to classify the HOI.

Some HOI detection techniques may be based on a human-centric approach, which may use human appearance as cues to detect the action and localize the object. However, such techniques may be limited to where the human and object are close to each other and cannot effectively identify human-object interactions when the object is far away from the human.

Some HOI detection technique may be a graph-based network, where the nodes represent both humans and objects, and the edges represent the interactions. However, such networks do not use spatial relation cues between human and object candidates for determining HOI. Other HOI detection techniques may be based on instance-centric attention module which is limited to the nearest region's information.

Some HOI detection techniques may be based on correlation of pair-wise human body parts. Other HOI detection techniques may be based on a pose configuration map formed via the combination of interactiveness prior (in datasets), human pose and spatial configuration. However, these techniques' use of human pose is limited to spatial constraint between the human parts and objects. Further, these techniques tend to either completely omit or only independently consider local or global aspects of contextual cues.

Some HOI detection techniques may use linguistic priors as external knowledge. For instance, such techniques incorporate information from WordNet using a graph convolutional network to compose new HOIs. However, since these linguistic priors are often adapted from the context of Wikipedia, they may not represent true semantic word-action meanings. Further, these word embeddings may not correlate with the semantic representations from visual cues. Hence, contextual meaning of the two sets of features, concerning the HOI, may differ. As a result, linguistic priors techniques may not work well for particular HOI pairs.

Some HOI detection techniques may be based on cascaded HOI networks that leverage sequences of increasingly fine approximations to control learning and inference complexity. Although such networks may learn HOI relations at the pixel level, these networks' use of mask only to learn feature representation may lose valuable context information.

Some HOI detection techniques may be based on a contextual attention framework, incorporating context into the human and object appearance features. Although combining global context may improve computer vision applications, such techniques may be noisy and add contradictory information to the feature representations in the case of HOI. This is because there may be multiple instances of interactive and non-interactive human-object pairs in an image.

To reduce the noise and contradictory information, global context, in embodiments described herein, may refer to the region surrounding the human-object pair rather than the entire image.

In some HOI detection techniques, the human-object pairwise stream may be based on an encoding technique representing the human and the object as a 2D binary channel. However, such techniques may be unable to differentiate between non-interacting human and object pairs, thereby, increasing the number of false positives.

Embodiments described herein may provide for a pipeline that utilizes human-object interactions to enhance image-editing. The pipeline may use any HOI algorithm for enhancing image-editing, as described herein. As may be appreciated by a person skilled in the art, a pipeline may refer to a system comprising a plurality of modules, wherein each module may be a separate algorithm. The pipeline may also refer to the overall system flow, from an input, through a plurality of modules, to the output, as described herein.

Embodiment may further provide for an enhanced HOI network as further described herein. Embodiment may further provide for a method that accentuates instance attention to human appearance features by conditioning on the pose. Embodiments may further provide an enhanced relation network that encodes spatial relationships between interacting and non-interacting pairs of humans and objects. Embodiments may further provide for enhanced spatial representation by conditioning the relations network's output with human pose, thereby enhancing the HOI detection.

Embodiments may further provide for a contextual embedding structure comprising encoded appearance and spatial features to capture both local and global context cues surrounding the human-object region. The local context may help the HOI network to learn information surrounding the region around human and object appearance features. The global context may aggregate the scene around the areas represented by the human-object relationship.

Embodiments may further provide for a pipeline that automatically filters objects associated with one or more humans in an image. Such filtering may provide for enhanced image-editing operations that filter object directly or indirectly interacting with the person of interest.

Embodiments may further provide for a more accurate HOI detection in an image as described herein. Embodiment may provide for a more accurate HOI detection via improved estimation of human actions using human pose. In some embodiments, human appearance features may be fused (via multiplicative operations as described herein) with pose information to detect more robustly the HOI in images. As may be appreciated by a person skilled in the art, human appearance features and pose information may act as complementary cues for improving HOIs detection in images. Further, by applying pose as an attention mechanism, human appearance may be less affected by colour of clothing, body shape, illumination, etc.

Embodiment may further provide for a more accurate HOIs detection via improved capturing of spatial relationship between humans and objects. In some embodiments, one or more relation networks may be used to embed visual features for integrating dependencies needed for relational reasoning between human(s) and object(s). These features may further be processed by operations such as concatenation and non-linear transformations and conditioned on the human pose to accentuate the visual relationship features.

Embodiments may further provide for a more accurate HOIs detection via improved context representations to jointly consider the humans, objects, and their environments. Embodiments may further allow the network to learn contextual information to support the appearance and spatial features. In some embodiments, the local context may be incorporated by conditioning the appearance features with spatial features. In some embodiments, the global context may encode the scene or environment attributes around the human-object proposal region as a whole entity.

As described herein, embodiments may provide for a pipeline 100 which may detect all human and object bounding boxes. For each human in the image, embodiments may combine bounding box and detection information for each object to create human-object proposals. For example, if there are M humans and N objects in an image, then a total of MxN proposals may be created. Embodiments may further classify each human-object proposal using HOI network 400 as described herein to determine whether the human-object proposal is an interactive class or not. Embodiments may generate human object masks for proposals that are considered to have an interaction.

As described herein, embodiments may provide for an automatic pipeline that utilizes Human-Object Interactions (HOI) to filter and retain the objects associated with the person of interest. Embodiments may further provide for an enhanced HOI network comprising one or more of: pose-based human appearance feature module, pose-aware spatial encoding module, and context-aware multi-feature embedding module as described herein.

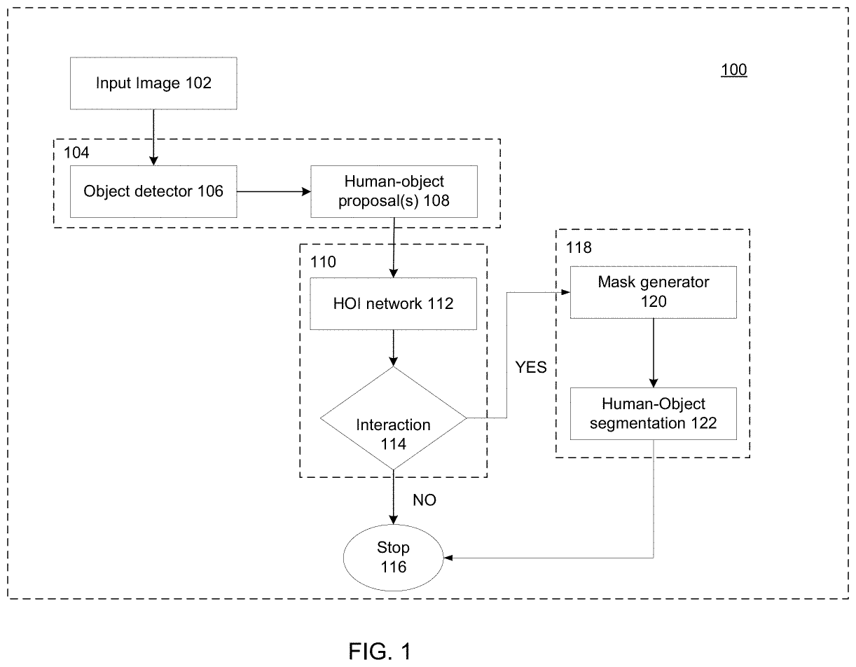

FIG. 1 illustrates a pipeline, according to an embodiment of the present disclosure. The pipeline 100 is illustrated as a flowchart and may be described as a method. The pipeline or method 100 may comprise receiving an input image 102. At 104, an object detector 106 may be used to detect all humans and objects in the input image. Object detector 106 may be any type of detectors used for detecting objects and humans in an image, such as Mask-RCNN. In some embodiments, an algorithm may be used to filter out the detected humans and object. The algorithm may be a simple post-processing stage (e.g., rule-based) or a more complex algorithm. In some embodiments, the algorithm may be separate from the object detector 106. Based on the detected humans and objects, one or more human-object proposals 108 may be created. Each human-object proposal may comprise or be based on one detected human and one detected object. Each human-object proposal may be associated with a proposal ID. For example, if the object detector detects 5 humans and 5 objects in the input image 102, then 25 human-object proposals may be created.

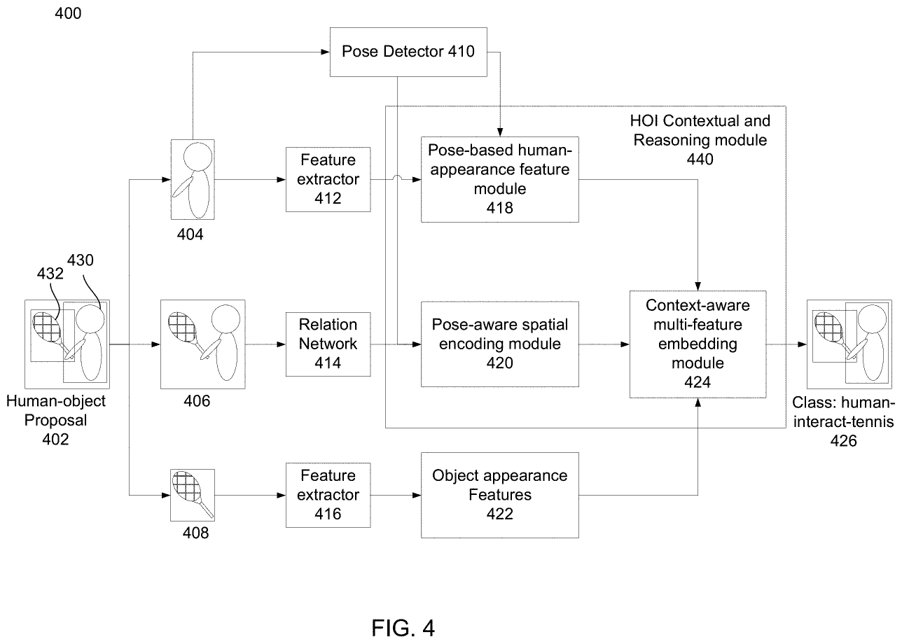

The created one or more human-object proposals may be fed into an HOI network 112. The HOI network 112 may be any HOI network (e.g. a context-aware relational reasoning (CRR) for HOI (CRR-HOI) network, including HOI 400 in FIG. 4) that can be used to determine whether an interaction exist between a human and an object in a human-object proposal.

At 110, for each human-object proposal, the HOI network 112 may determine whether an interaction 114 exist between the human and the object. If HOI network 112 determines that no interaction exists in a human-object proposal (e.g., that the human-object proposal is a non-interactive proposal), then an indication reflecting the determination that no interaction exists in the human-object proposal maybe outputted. The procedure may then end (e.g., Stop 116) with respect to the non-interactive human-object proposal.

If HOI network 112 determines that an interaction exists in a human-object proposal (e.g., that the human-object proposal is an interactive proposal), then, at 118, a mask generator 120 e.g., Mask-RCNN, may be used to generate a segmentation mask (human-object segmentation) based on the determined interaction. The human-object segmentation 122 may then be outputted, and the procedure ends (e.g., Stop 116) with respect to the interactive human-object proposal.

Accordingly, the HOI network 110 may be used to identify interacting pairs of humans and objects in the image 102. Further, the pipeline 100 may provide for human-object segmentations outputs 122 which may be used for a variety of applications.

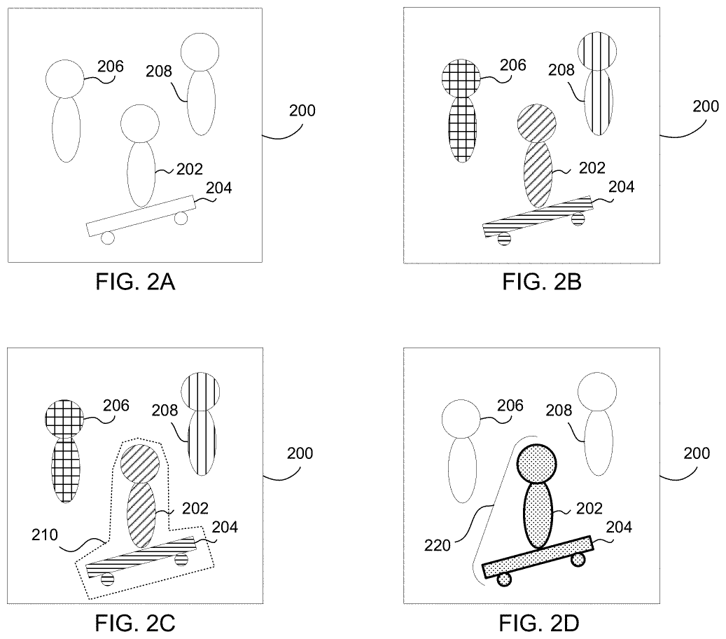

FIG. 2A-2D are visual illustrations of the pipeline in FIG. 1, according to an embodiment of the present disclosure. FIG. 2A may refer to an input image 200 (which may refer to, for example, image 102) comprising humans 202, 206, and 208, and object 204. The image 200 may be received as discussed in reference to FIG. 1. In reference to 104, an object detector 106 may be used to detect all humans (e.g., humans 202, 206, 208) and objects (e.g., object 204) in image 200. Each detected human and object may be indicated via a different line pattern as illustrated in FIG. 2B.

In some embodiments, an algorithm may be used to filter out the detected humans and object. Based on the detected humans and objects, one or more human-object proposals may be created via, for example, an object detector such as Mask-RCNN. Referring to FIG. 2B, image 200 comprises 3 humans 202, 206, and 208 and 1 object 204, accordingly, 3 human-object proposals may be created: (206, 204), (202, 204), and (208, 204).

The created proposals are then fed into an HOI network (e.g., HOI network 112) to determine whether an interaction exist in each of the created proposals. According to an embodiment of proposal (206, 204) is fed into the HOI network. The HOI network may determine that no interaction exist between human 206 and object 204. An indication may be outputted indicating that the proposal (206, 204) is a non-interactive proposal. Similarly, proposal (208, 204) may be fed into the HOI network, and the HOI network may determine that no interaction exist between human 208 and object 204. An indication may be outputted indicating that the proposal (208, 204) is a non-interactive proposal.

Proposal (202, 204) may then be fed into the HOI network. The HOI network may determine that an interaction exist between human 202 and object 204. Accordingly, the HOI network may determine that the proposal (202, 204) is an interactive proposal. In some embodiments, HOI network may determine that proposal 210 may fall under an interaction class 210, for example, as referenced in FIG. 2C. The proposal ID associated with proposal (202, 204) may then be sent to a mask generator (e.g., mask generator 120). The mask generator may generate a segmentation mask 220 (similar to human-object segmentation mask 122) for proposal (202, 204) as illustrated in FIG. 2D. The segmentation mask for the interacting human-object pair (202, 204) may then be outputted. Accordingly, the segmentation mask 220, which is based on the determined interactive proposal (202, 204), may be saved and the non-interactive proposals (e.g., (206, 204), (208, 204)) may be discarded.

Embodiment described in reference to the pipeline may provide for segmentation regions for interactive human-object pairs in an image. Embodiments may further provide for application of image-processing techniques to persons and object associated or interacting with the persons via using human object relationship information derived from determined HOI.

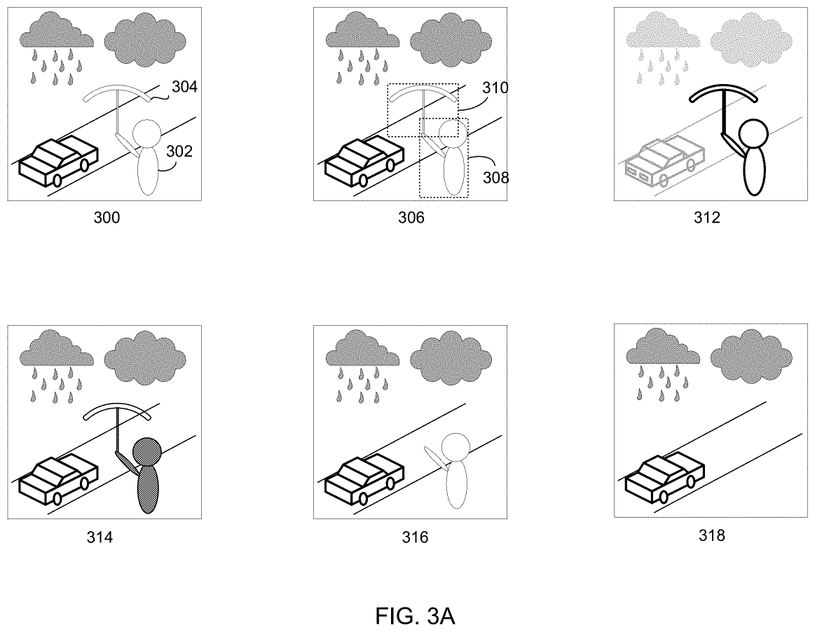

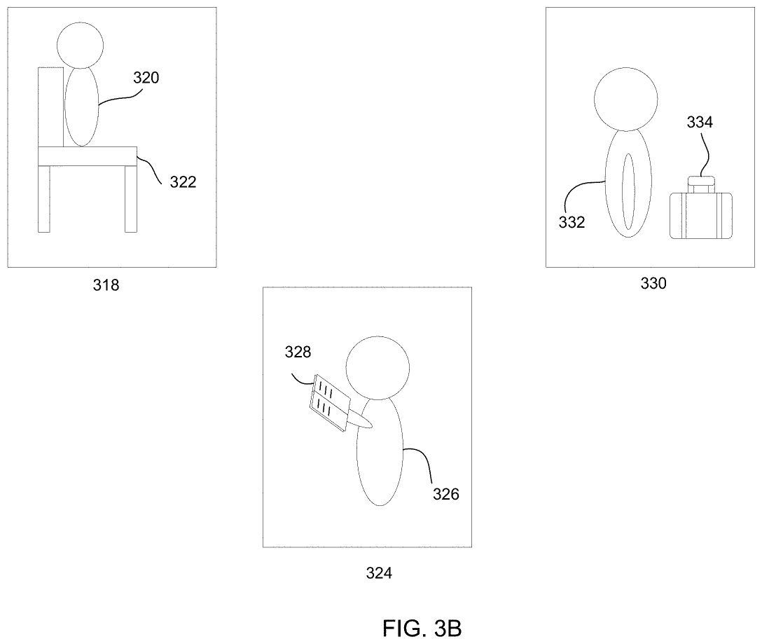

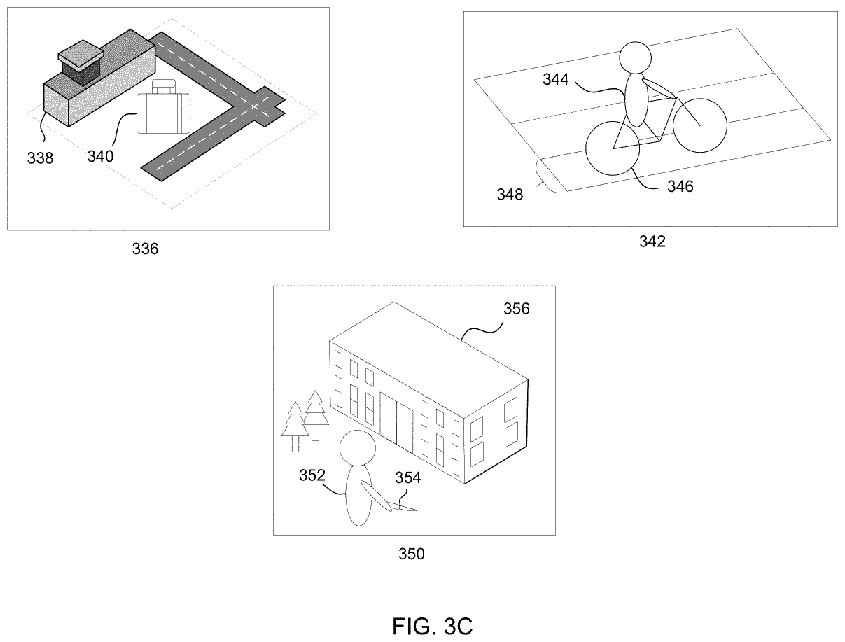

FIG. 3A illustrates examples applications of the pipeline of FIG. 1, according to an embodiment of the present disclosure. FIG. 3A relates to image editing applications based on HOI as per the pipeline 100. Referring to FIG. 3, an image 300 may comprise a human 302 holding an umbrella (an object 304). The image 300 may further includes clouds and a car, for example, as illustrated. As discussed herein, one or more human-object proposal according may be created and fed through an HOI network for determining whether an HOI exist in each human-object proposal, according to pipeline 100. As illustrated in 306, human-object proposal (308, 310) indicated by bounding box 308 (comprising human region) and 310 (comprising object region) may be determined to an interactive proposal, for example, according to pipeline 100. Segmentation masks may be generated based on the interactive proposal (308, 310) and saved for image-editing operations.

In an embodiment, image 300 may be edited to create a portrait mode (e.g., bokeh effect) of one or more of the interacting human 302 and object 304 pair as illustrated in image 312. In image 312, HOI determined according to pipeline 100 may be leveraged to focus the portrait mode on the human 302 and the object 304 as indicated, for example, by bolded lines, whereas the rest of the image (the clouds and the car) is faded, as illustrated.

In another embodiment, image 300 may be edited to, for example, alter the color of one or more of the interacting human 302 and object 304. Image 314 illustrates altering the color of the object 304 (e.g., AI color application) alone. In image 314, HOI determined according to pipeline 100 may be leveraged to alter the color of the object 304, as indicated, for example, by fill patterns, whereas the rest of the image remains, including the object 304 interacting with the human, is unaltered as illustrated.

In another embodiment, image 300 may be edited to, for example, remove one or more of the interacting human 302 and object 304 pair from the image 300 and refill the removed region (e.g., inpainting). In image 316, HOI determined according to pipeline 100 may be leveraged to only remove the object 304 and refill the regions removed as illustrated. In another embodiment, HOI determined according to pipeline 100 may be leveraged to remove the interacting human 302 and object 304 pair and refill the regions removed as illustrated, as illustrated in image 318.

Accordingly, embodiments described in reference to FIG. 3A may provide for various image editing applications. Embodiments may provide for image editing that can be applied to one or more of: a person recognized as interacting with an object (an interacting person); an object recognized as interacting with a person (an interacting object), the image excluding an interacting human-object pair, the image excluding an interacting person, the image excluding an interacting object, a non-interacting person or a non-interacting object. A person skilled in the art may appreciate that there may be other image editing applications for which the pipeline may provide for. In some embodiments, the systems and methods described herein can be used for image editing of the interacting human and object pair.

Pipeline 100 may further be used for other applications such as in the context of human-object affordances, as illustrated in FIG. 3B. FIG. 3B illustrates further example applications of the pipeline of FIG. 1, according to an embodiment of the present disclosure. In an embodiment, an image 318 may be fed through pipeline 100 to create a human-object proposal (320, 322). According to the pipeline 100, the human-object proposal (320, 322) may be determined to be an interactive proposal. In some embodiment, according to the pipeline 100, the HOI determined may indicate, for example, a relationship between human 320 and the object 322 (e.g., chair). The relationship may indicate that the human 320 is occupying (e.g., sitting) the object 322 (e.g., chair), as illustrated. In some embodiments, the HOI may further indicate that due to the nature of the HOI (e.g., human 320 sitting on a chair 322), human 320 may get hurt if another HOI involving the object 322 and another human takes place (e.g., another human attempts to or sits on the object 322).

In another embodiment, an image 324 may be fed through pipeline 100 to create a human-object proposal (326, 328). According to the pipeline 100, the human-object proposal (326, 328) may be determined to be an interactive proposal. In some embodiment, according to the pipeline 100, the HOI determined may indicate, for example, a relationship between human 326 and the object 322 (e.g., a book). The HOI may indicate that the human 326 is reading a book (object 322) as illustrated. In some embodiments, the HOI may further indicate that due to the nature of the HOI (e.g., human 326 reading a book 328), human 320 may react (e.g., become mad) if another HOI involving the object 328 and another human takes place (e.g., another human attempts to or grasps on the object 328). In some embodiments, the HOI may further indicate that another HOI involving the object 328 and another human (e.g., another human attempts to or grasps on the object 328) may violate the law.

In another embodiment, an image 330 may be fed through pipeline 100 to create a human-object proposal (332, 334). According to the pipeline 100, the human-object proposal (332, 334) may be determined to be an interactive proposal. In some embodiment, according to the pipeline 100, the HOI determined may indicate, for example, a relationship between human 332 and the object 334 (e.g., a suitcase). The HOI may indicate that the human 326 is within a close proximity to a suitcase on a surface (object 324) as illustrated. In some embodiments, the HOI may further indicate that due to the nature of the HOI (e.g., human 326 being close to the suitcase), human 332 may react (e.g., become mad) if another HOI involving the object 332 and another human takes place (e.g., another human attempts to or grasps on the object 334). In some embodiments, the HOI may further indicate that another HOI involving the object 334 and another human (e.g., another human attempts to or grasps on the object 334) may violate the law.

As described in reference to FIG. 3B, embodiments may provide for human-object knowledge. Embodiment may further leverage human-object knowledge for applications in other computer visions tasks such as affordances and tracking as further described in reference to FIG. 3C.

Pipeline 100 may further be used for smart city or smart home applications. Pipeline 100 may be used to track impermissible human interactions with object under different scene contexts to detect abnormalities. Pipeline 100 may further be used to track objects under different scene contexts to detect abnormalities.

FIG. 3C illustrates yet further example applications of the pipeline of FIG. 1, according to an embodiment of the present disclosure. In an embodiment, an image 336 may be fed through pipeline 100. The image 336 may indicate a scene context (e.g., airport 338). In some embodiments, the scene context may be determined manually (e.g., by an engineer or an installer) or via a scene-detecting algorithm. In some embodiments, the scene context (e.g., airport 338) may be associated with normal or expected HOI(s) (e.g., a human-backpack interaction such as a human holding or carrying a backpack in airport). Pipeline 100, via the object detector 106, may detect one or more humans (in the case of image 336, no humans may be indicated) and object (e.g., backpack 340).

According to pipeline 100, one or more human-object proposals may be created based on the image 336 and fed to the HOI network. The HOI network may determine that no HOI exists involving the object 340. While image 336 does not include any human, in another embodiment, one or more humans may be present in the image, however, the pipeline may still determine that no HOI interaction exist between the one or more humans and the backpack.

In the case of image 336, since only the object 340 may be detected and no human, pipeline 100 may automatically determine that no human is interacting with the object 340. Given the scene context (e.g., an airport 338) and the determination that no human is interacting with the object. Accordingly, a determination may be made that the image 336 indicates an abnormal scene (e.g., detection of a backpack but no human interaction involving the backpack in an airport setting (scene context) which may be contrary to the associated normal or expected HOI(s)). The determination may be based on one or more of: the scene context (e.g., airport 338), the associated normal or expected HOI(s), the detection of an object 340 (backpack), and a determination that no HOI exists involving the object 340. Accordingly, in some embodiments, a warning indication may be triggered to flag the abnormal scene.

In some embodiments, the image may include humans and objects, and after generating human-object proposals using the detected humans and objects, and feeding these into the HOI network, the pipeline 100, via the HOI network, may still determine that no human interaction exists with a detected object. And accordingly, a determination may be made that the image indicates an abnormal scene.

In another embodiment, an image 342 may be fed through pipeline 100. The image 342 may indicate with a scene context (e.g., curbside 348). In some embodiments, the scene context may be determined manually (e.g., by an engineer or an installer) or via a scene-detecting algorithm. In some embodiments, the scene context (e.g., curbside 348) may be associated with a rule (e.g., no biking allowed on the curbside). In some embodiments, the scene context (e.g., curbside 348) may be associated with a normal or expected HOI(s) based on the rule (e.g., a human-human interaction, human-backpack interaction, etc.). The pipeline 100 may detect one or more humans (e.g., human 344) and object (e.g., bike 346).

According to pipeline 100, one or more human-object proposals (e.g., human-object proposal (344, 346)) may be created based on the image 342 and fed to the HOI network. The HOI network may determine that an interaction exist between human 344 and object 346 indicating that the proposal (344, 346) is an interactive proposal.

As such, a determination may be made that the image 336 indicates an abnormal scene (e.g., an indication of HOI (human riding a bike) on curbside setting (scene context), which may be contrary to one or more of: associated rules, or associated normal or expected HOI(s)). The determination may be based on one or more of: the scene context (e.g., curbside 348), the rules associated with the scene, associated normal or expected HOI(s), a determination that an HOI exists that is contrary to the one or more of: rule associated with the scene context, and the normal or expected HOI(s) associated with the scene context. Accordingly, in some embodiments, a warning indication may be triggered to flag the abnormal scene.

In another embodiment, an image 350 may be fed through pipeline 100. The image 350 may indicate a scene context (e.g., school 356). In some embodiments, the scene context may be determined manually (e.g., by an engineer or an installer) or via a scene-detecting algorithm. In some embodiments, the scene context (e.g., school 356) may be associated with normal or expected HOI(s) (e.g., a human-human interaction, human-backpack interaction, human-book interaction, human-coffee interaction, human-laptop interaction, etc.). The Pipeline 100 may detect one or more humans (e.g., human 352) and object (e.g., knife 354).

According to pipeline 100, one or more human-object proposals (e.g., human-object proposal (352, 354)) may be created based on the image 350 and fed to the HOI network. The HOI network may determine that an interaction exist between human 352 and object (knife 354) indicating that the proposal (352, 354) is an interactive proposal.

As such a determination may be made that the image 350 indicates an abnormal scene (e.g., an indication of HOI (human carrying a knife) on school setting (scene context), which may be contrary to associated normal or expected HOI(s)). The determination may be based on one or more of: the scene context (e.g., school 356), associated normal or expected HOI(s), a determination that an HOI exists that is contrary to the normal or expected HOI(s) associated with the scene context. Accordingly, in some embodiments, a warning indication may be triggered to flag the abnormal scene.

FIG. 4 illustrates an HOI network, according to an embodiment of the present disclosure. The HOI network 400 may be a CRR-HOI network. According to an embodiment, one or more human object proposals (e.g., human-object proposal 402 (comprising human 430 and object 432 (e.g., tennis racket)) may be created and fed to the HOI network. The image (according to the proposal 402) may be duplicated and cropped according to the bounding boxes 404 and 408. Bounding box 404 may be referred to as the human-crop and represent the portion of the image comprising the human region. The bounding box 408 may be referred to as the object-crop and represent the portion of the image comprising the object region, as illustrated. The bounding box 406 may refer to human-object crop and correspond to the region containing, for example, the tightest bounding box of the human and the object bounding boxes (i.e., 404 and 408). By enabling the tightest bounding box 406, the HOI network 400 may maintain spatial invariance as the human-object interaction can occur anywhere in the image.

In embodiment, the HOI network 400 may comprise a pose detector 410 such as OpenPose, CenterNet, etc. to extract pose features or pose information of the human in the image. Accordingly, in an embodiment, the human-crop 404 may be fed to a pose detector 410 to extract pose feature of the human 430. The HOI network may further comprise a feature extractor 412 such as ResNet50, MobileNetV2, etc. to extract, e.g., appearance features from the human in the image. Accordingly, in an embodiment the human-crop 404 may also be fed to a feature extractor 412 to extract appearance feature of the human 430.

The HOI network 400 may further comprise an HOI contextual and reasoning module 440 comprising one or more of: pose-based human appearance feature module 418 (or may be referred to pose-based human-appearance algorithm), pose-aware spatial encoding module 420 (or may be referred to as spatial encoding algorithm), and context-aware multi-feature embedding module 424 (or may be referred to as context aware multi-feature algorithm).

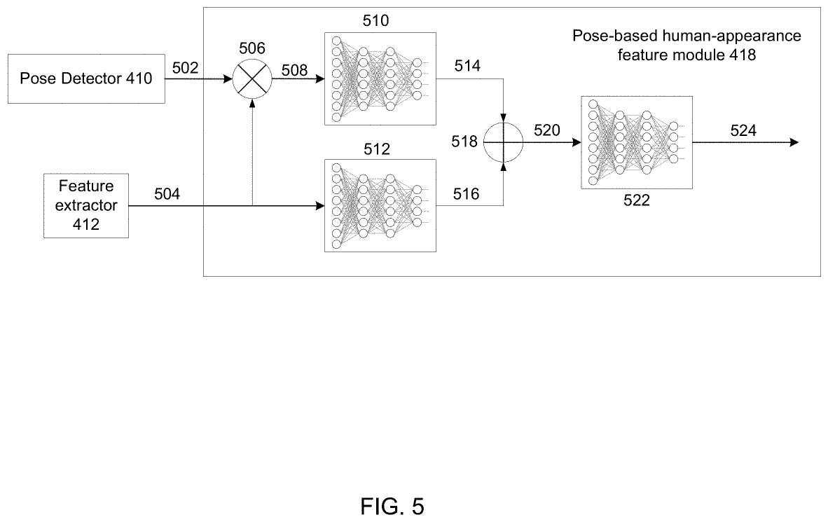

In an embodiment, outputs from the pose detector 410 and feature extractor 412 may be fed into the pose-based human appearance feature module 418 to generate a more representative features of the human 430 as further described herein in reference to FIG. 5.

The HOI network 400 may further comprise a relation network 414 to extract spatial features from the human-object crop 406. The relation network 414 may be a neural network module for relational reasoning. In an embodiment, the human-object crop 406 may be fed into the relation network 414 to extract spatial features.

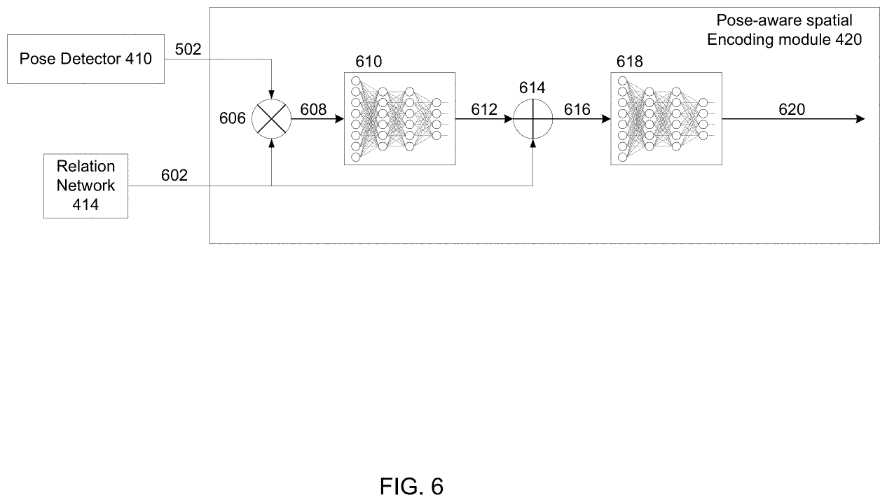

In an embodiment, outputs from the pose detector 410 and the relation network 414 may be fed into the pose-aware spatial encoding module 420 as further described herein in reference to FIG. 6.

The HOI network may further comprise a feature extractor 416 such as ResNet50, MobileNetV2, etc. to extract, e.g., appearance features from the object 432 in the image. Accordingly, in an embodiment the object-crop 408 may also be fed to a feature extractor 416 to extract appearance feature of the object 422 as illustrated.

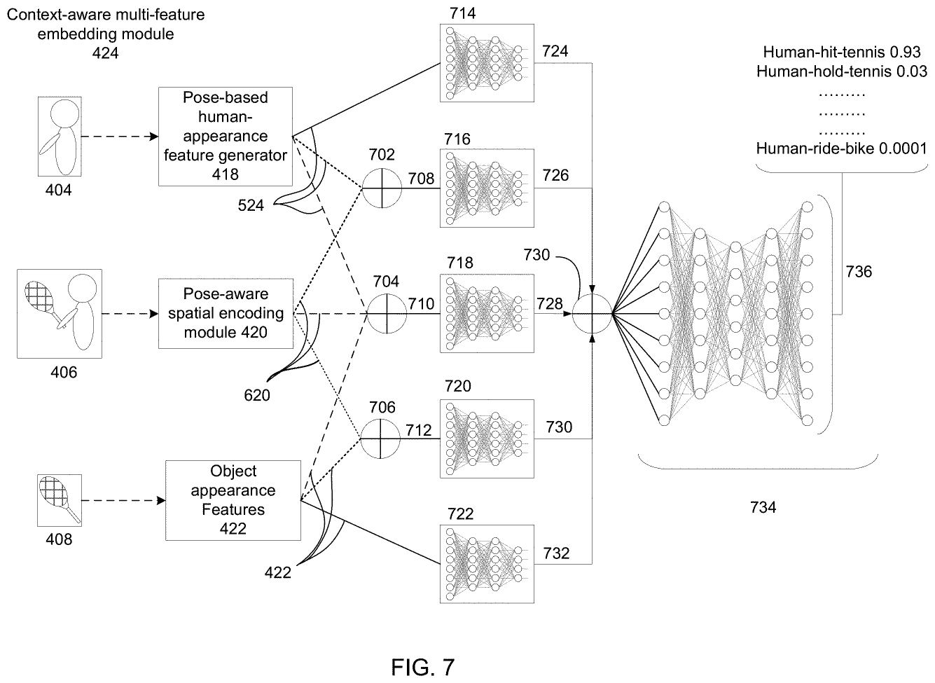

The context aware multi-feature embedding module 424 may be used for encoding local and global contextual information on the appearance and spatial features. In an embodiment, outputs from one or more of: pose-based human-appearance feature module 418, pose aware spatial encoding module 420, and feature extractor 416 (e.g., object appearance features 422) may be fed into the context aware multi-feature embedding module 424 as described in reference to FIG. 7. Based on the received information, the context aware multi-feature embedding module may determine an interactive class (e.g., human-interact-tennis) for the human-object proposal 402.

Accordingly, embodiments described in reference to FIG. 4 may provide for accurate detection of HOI in an image. Such embodiments may further provide for accurate detection of interacting pairs of humans and object in an image.

FIG. 5 illustrates pose-based human appearance feature module, according to an embodiment of the present disclosure. As described in reference to FIG. 4, outputs (e.g., 502) from the pose detector 410 and outputs (e.g., 504) from feature extractor 412 may be fed into the pose-based human appearance feature module 418. The pose-based human appearance feature module 418 may perform one or more operations as described herein.

In an embodiment, the pose-based human appearance feature module 418 may receive outputs from pose detector 410 and feature extractor 504 (e.g., information 502 (pose information) and 504 (appearance information)). The pose-based human appearance feature module 418 may apply multiplicative operation 506 to received information 502 and 504 to obtain output 508. In some embodiments multiplicative operations may include dot-product operation as may appreciated by a person skilled in the art.

As may be appreciated by a person skilled in the art, in an embodiment, the human appearance features may be conditioned on the body pose, since pose may play a vital role in daily interactions with other humans and objects. The multiplicative operation 506 applied to the pose and initial appearance features, respectively 502 and 504, may apply local attention to the human appearance features, as may be indicated in multiplicative output 508. In some embodiments, the pose-based human appearance feature module 418 may further apply non-linear transformations on the multiplicative output 508 via neural network 510 to obtain improved feature outputs 514. The neural network 510 may refer to any fully connected neural network.

In some embodiments, the pose-based human appearance feature module 418 may apply non-linear transformation on the extracted feature appearance 504 via a neural network 512 to generate outputs 516. The shallow network 512 may be similar to the neural network 510.

In some embodiments, the outputs of the non-linear transformations, e.g., outputs 514 and 516, may be concatenated 518 to generate a more improved pose-appearance feature output 520. In some embodiments, the pose-based human appearance feature module 418 may apply non-linear transformation, via neural network 522, to inputs 520 to generate outputs 524 (pose-based human-appearance features). Accordingly, via the concatenation and non-linear transformation operations (518, and 522 respectively) pose-based human-appearance feature module may provide for a representation that jointly learns more finer-grained lower-level appearance features while maintaining the pose-conditioning. As may be appreciated by a person skilled in the art, output 524 may comprises information on human appearance feature conditioned on human pose behavior based on multiplicative and concatenative operations, and non-linear transformation via neural networks as described.

FIG. 6 illustrates pose-aware spatial encoding module, according to an embodiment of the present disclosure. The pose-aware spatial encoding module 420 may be used to help the HOI network 400 to learn the visual relationship between the human 430 and the object 432. As such, the human-object crop 406 fed to the relation network 414 may be the tightest bounding box of the human 430 and the object 432, thereby maintaining spatial invariance. Since an HOI may appear anywhere in an image, even though in proposal 402 the HOI is appearing in the middle of the image, using the tightest bounding box 406 to define the human-object crop may maintain spatial invariance. The pose-aware spatial encoding module 420 may be used to help the HOI network 400 learn how the HOI in proposal 402 may be occurring within the space surrounding the HOI, or human 430 and object 432.

As described in reference to FIG. 4, outputs 502 from the pose detector 410 and outputs 602 from the relation network 414 may be fed into the pose-aware spatial encoding module 420. The relation network 414 may extract spatial features (e.g., 602) from the tightest human-object bounding box (i.e., human-object crop). As may be appreciated by a person skilled in the art, the extracted spatial features 602 comprises spatial relationships between human 430 and the object 432. As described herein, the HOI network 400 is fed with a human-object proposal 402 (rather than the entire image, which may include other humans and objects), and the human-object crop is based on the proposal 402 as described herein. Since the human 430 and object 432 may interact with each other in various ways, the pose-aware spatial encoding module 420 may leverage the pose features 502 with the spatial relationship 602 to obtain a more representative and accurate feature of the HOI. The pose-aware spatial encoding module 420 may perform one or more operations as described herein.

In an embodiment, pose-aware spatial encoding module 420 may apply multiplicative operations 606 to the received information (e.g., outputs 502 and 602) to generate output 608. Accordingly, the pose-aware spatial encoding module 420 may apply multiplicative operation to the resultant 1-D vector (e.g., output 602) and the pose features (e.g., output 502). As may be appreciated by a person skilled in the art, as a result of the multiplicative operation 606, spatial relationship may be encoded by conditioning the spatial relationship on the human body pose features, since the determination of HOI may be based on human pose features. As may be appreciated by a person skilled in the art, in some embodiments, there may be other objects interacting with the human 430, even though the other objects may be, spatially, further located from the human than the object 432, and thus the HOI may be better determined via pose feature information 502 than just spatial relationships. So, by conditioning the spatial relationship on the human body pose feature, the pose-aware spatial encoding module 420 may leverage the pose feature information with the spatial relationship in determining whether an HOI exists and the nature of the HOI. Accordingly, local attention may be provided to the visual-relationship features by applying multiplicative operations, thereby encoding human-object relationships into the HOI network 400. The information from pose feature may be leveraged to further enrich the spatial relationship derived via the relation network.

In some embodiments, the resultant features 608 may be passed through another neural network 610 applying non-linear transformation to obtain output 612. Neural network 610 may be similar to neural network 510. In some embodiments, the linearly transformed output 612 is then concatenated 614 with outputs 602 of the relation network to generate output 616. In some embodiments, output 616 may further be encoded via another neural network 618 applying non-linear transformation to produce pose-aware spatial encoded features 620. The neural network 618 may be similar to the neural network 610.

As described herein, pose-aware spatial encoding module 420 may leverage relation network outputs for detecting human-object spatial features. Further, a more accurate special features may be obtained since embodiments described herein may provide for differentiating interacting human-object pairs from and non-interacting human-object pairs.

FIG. 7 illustrates context-aware multi-feature embedding module, according to an embodiment of the present disclosure. Multi-feature may refer to one or more feature comprising: pose-based human appearance features 524, pose-aware spatial encoded features 620 and object appearance features 422. Context-aware may refer to the environment around, for example, the human 430 and object 432 in the image. In an embodiment, the environment may indicate a green field which may provide further information on the HOI taking place in the image. As may be appreciated by a person skilled in the art, the environment in which the HOI takes place may play a role on determining the type of HOI, and thus taking into consideration the environment (i.e., the context) in which the human and object are interacting adds a further layer of helpful information to filter the determination and nature of HOI taking place in an image. Accordingly, context-aware multi-feature embedding module 424 may be used to embed such context representation associated with the HOI in the HOI network 400.

The context-aware multi-feature embedding module 424 may encode local and global contextual information on the appearance and spatial features. Local contextual information may refer to local to the human 430 and the object 432 only. Accordingly local contextual information may look into the immediate pixels surrounding and adjacent to each of the human 430 and the object 432 individually. In embodiment, the local contextual information may be based on for example, the bounding boxes 404 (the human-crop) and 408 (the object-crop). The global contextual information may be based on the human and object collectively, which may be based on the bounding box 406, the human-object crop. Thus, the global contextual information may refer to the immediate pixels surrounding and adjacent to the human 430 and the object 432 collectively.

Referring to FIG. 7, the dotted lines illustrate that local contextual encoding may be applied to the human and object appearance features. In some embodiments, pose-based human appearance features 524 may be concatenated 702 with the pose aware spatial features 620 to obtain local context on the human 430 individually. Similarly, in some embodiments, object appearance features 422 may be concatenated 706 with the pose-aware spatial features 620 to obtain local context on the object 432 individually. This way, the context region (local context) around the human 430 and the object 432 may be encoded individually.

The dashed lines in FIG. 7 may refer to global contextual encoding. In some embodiments, pose-based human appearance features 524, pose-aware spatial encoding features 620 and object appearance features 422 may all be concatenated 704 to obtain global context. Accordingly, the scene or environment attributes around the human-object proposal region as a whole entity may be encoded.

In some embodiments, outputs 708, 710, and 712 of each concatenation operations 702, 704, and 706 respectively, may be passed through neural networks (716, 718, and 720 respectively) for performing non-linear transformations. In some embodiments each of the pose-based human appearance features 524 and object appearance features 422 may be passed through neural networks 714 and 722, respectively, for applying non-linear transformations. As may be appreciated by a person skilled in the art, the neural networks (e.g., 714, 716, 718, 720 and 722) may help find improved combination or representations of the incoming appearance (human and object) and spatial feature vectors, where both local and global context are human-object centric.

In some embodiments, the one or more resultant feature vector outputs (e.g., 724, 726, 728, 739 and 732) of the neural networks (714, 716, 718, 720 and 722 respectively) may be concatenated 730 for the HOI network 400 to jointly learn the local and global context. In some embodiments, the output of the concatenation operation 730 may be further passed through a neural network 734, where the output nodes may be equal to or indicate the number of HOI classes. The neural network 734 may be a dense neural network for applying the required non-linear transformations, as may be appreciated by a person skilled in the art. In an embodiment, the output nodes of the neural network 734 may correspond to a number of actions (or HOI classes) for which the neural network 734 may be trained. Examples of HOI classes or actions may include human-hit-tennis, human-hold-tennis racket, human-ride-bike etc. Accordingly, for each HOI class, the neural network 734 may generate an output 736 indicating a probability of the HOI class for the human-object proposal 402.

Embodiments described herein may provide for incorporating contextual features surrounding the human-object pair to improve feature representations. As described herein, local context may focus on the humans and objects separately and conditioned on the human-object pair. Further, global context may focus on the appearance and spatial features combined.

A person skilled in the art may appreciate that neural networks referenced to FIG. 5-7 (e.g., neural networks 510, 512, 522, 610, 618, 714, 716, 718, 720, 722) may refer to any neural network capable of performing the required operations as described herein. Although deep neural networks may be used to perform the non-linear transformations, since embodiments provide for applying multiplicative and concatenative operations on features derived from bounding boxes and human-object proposal as described herein, use of shallow neural network to perform the non-linear transformation of the referenced neural networks may be sufficient.

In some embodiments, the HOI network 112 reference in FIG. 1 with respect to pipeline 100 may be the HOI network 400 described herein. Accordingly, in some embodiments, the output from HOI network 112 (e.g., HOI network 400) may indicate the HOI class as referenced in FIG. 7 with respect to the neural network 734. Accordingly, use of HOI network 400 in pipeline 100 may provide for a more accurate pipeline applications as described herein.

Embodiments described in reference to the HOI network 400 may provide for improved spatial encoding that may enhance learning visual relationships. Embodiments may further provide for an HOI network that learns representations of interacting and non-interacting pairs of humans and objects. Embodiment may further provide for appearance features conditioned on human pose features as described herein.

Embodiment described herein may provide for local and global contextual features. The local contexts may capture the region around the humans and objects individually, whereas the global may capture the region surrounding the entire human-object pair. Embodiment may further provide for contextual features that are further conditioned on the spatial features, to provide for a more human-object centric features.

Embodiment described in reference to pose-based human appearance feature module may provide for improved estimation of human actions. Embodiment described in reference to pose-aware spatial module may provide for a more accurate capturing of spatial relationships between humans and objects. Embodiments described in reference to context-aware multi-feature embedding module may provide for improved contextual information by jointly considering the human, objects, and their environments as described herein.

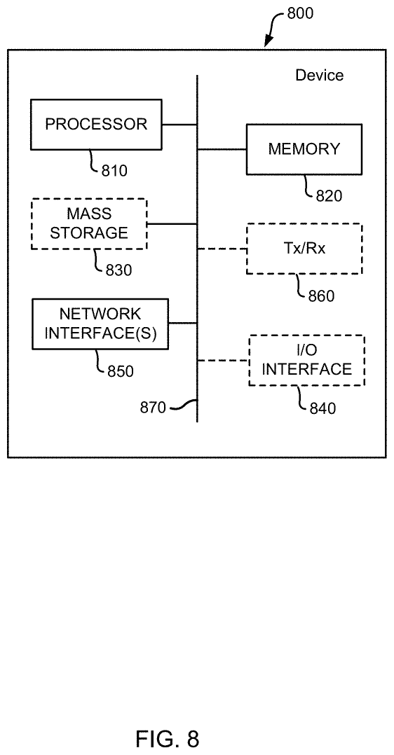

FIG. 8 illustrates a device that may perform any or all of operations of the methods and features explicitly or implicitly described herein, according to different embodiments of the present disclosure. In some embodiments, device 800 may include a user equipment. In some embodiments one or more of the following: pipeline 100, modules 418, 420 and 424, may be deployed on device 800, for example.

As shown, the device 800 may include a processor 810, such as a Central Processing Unit (CPU) or specialized processors such as a Graphics Processing Unit (GPU) or other such processor unit, memory 820, non-transitory mass storage 830, input-output interface 840, network interface 850, and a transceiver 860, all of which are communicatively coupled via bi-directional bus 870. According to certain embodiments, any or all of the depicted elements may be utilized, or only a subset of the elements. Further, device 800 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 820 may include any type of non-transitory memory such as static random access memory (SRAM), dynamic random access memory (DRAM), synchronous DRAM (SDRAM), read-only memory (ROM), any combination of such, or the like. The mass storage element 830 may include any type of non-transitory storage device, such as a solid state drive, hard disk drive, a magnetic disk drive, an optical disk drive, USB drive, or any computer program product configured to store data and machine executable program code. According to certain embodiments, the memory 820 or mass storage 830 may have recorded thereon statements and instructions executable by the processor 810 for performing any of the aforementioned method operations described above.

Embodiments of the present invention can be implemented using electronics hardware, software, or a combination thereof. In some embodiments, the invention is implemented by one or multiple computer processors executing program instructions stored in memory. In some embodiments, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include a number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for detecting human-object interaction (HOI) in an image, the method comprising:
receiving the image;
detecting at least one human in the image;
detecting at least one object in the image;
creating one or more proposals, each of the one or more proposals comprising a human of the at least one human and an object of the at least one object; and
determining whether an HOI exists in each of the one or more proposals.

2. The method of claim 1 further comprising:
generating a mask for each proposal of the one or more proposals in which an HOI is determined to exist, the mask generated based on the determined HOI.

3. The method of claim 1, wherein the determining comprises:
extracting human feature information from the one or more proposals;
extracting object appearance feature information from the one or more proposals; and
determining whether an HOI exists between the human and the object based at least in part on the human feature information and the object feature information.

4. The method of claim 3 further comprising:
extracting spatial feature information from the one or more proposals, the spatial feature information related to the human and the object;
wherein the HOI determination is further based on the spatial feature information.

5. The method of claim 2 further comprising;
editing the image based on the generated mask.

6. A method for determining a human-object interaction (HOI) from a proposal, the method comprising:
receiving the proposal comprising a human and an object, the proposal created based on an image;
extracting human feature information from the proposal;
extracting object appearance feature information from the proposal;
extracting spatial feature information from a human-object crop determined according to boundaries of the human and the object in the image; and
determining whether an HOI exists between the human and the object based on the human feature information, the object feature information, and the spatial feature information.

7. The method of claim 6, wherein the extracting human feature information from the proposal comprises:
extracting human pose feature information from a human-crop, the human-crop
determined according to boundaries of the human in the image; and
extracting human appearance feature information from the human-crop.

8. The method of claim 7, wherein the extracting object appearance feature information from the proposal comprises:
extracting the obj ect appearance feature information from an obj ect-crop determined according to boundaries of the object in the image.

9. The method of claim 8, wherein the determining comprises:
applying multiplicative operation to the human pose feature information and the human appearance feature information to generate a first pose-based human appearance feature output;
applying, via a first neural network, non-linear transformation to the first pose-based human appearance feature output to generate a second pose-based human appearance feature output;
applying, via a second neural network, non-linear transformation to the human appearance feature information to generate human appearance output;
concatenating the second pose-based human appearance feature output with the human appearance output to generate a third pose-based human appearance feature output; and
applying, via a third neural network, non-linear transformation to the third pose-based human appearance feature output to generate a fourth pose-based human appearance feature output.

10. The method of claim 9 further comprising:
applying multiplicative operation to the human pose feature information and the spatial feature information to generate a first pose-aware spatial feature output;
applying, via a fourth neural network, non-linear transformation to the first pose-aware spatial feature output to generate a second pose-aware spatial feature output;
concatenating the second pose-aware spatial feature output with the spatial feature information to generate a third pose-aware spatial feature output; and
applying, via a fifth neural network, non-linear transformation to the third pose-aware spatial feature output to generate a fourth pose-aware spatial feature output.

11. The method of claim 10 further comprising:
generating a first human local context output based on concatenation of the fourth pose-based human appearance feature output and the fourth pose-aware spatial feature output;
applying, via a sixth neural network, non-linear transformation to the first human local context output to generate a second human local context output;
generating a first human-object global context output based on concatenation of: the fourth pose-based human appearance feature output, the fourth pose-aware spatial feature output, and the object appearance feature information;
applying, via a seventh neural network, non-linear transformation to the first human-object global context output to generate a second human-object global context output;
generating a first object local context output based on concatenation of the fourth pose-aware spatial feature output and the object appearance feature information; and
applying, via an eighth neural network, non-linear transformation to the first object local context output to generate a second object local context output.

12. The method of claim 11 further comprising:
generating a context aware multi-feature output based on concatenation of: the second human local context output, the second human-object global context output and the second object local context output; and
applying, via a ninth neural network, non-linear transformation to the context aware multi-feature output to generate an indication of the HOI.

13. The method of claim 11, wherein the first, the second, the third, the fourth, the fifth, the sixth, the seventh, and the eighth neural networks are shallow fully connected neural networks.

14. The method of claim 11, wherein the ninth neural network is a dense neural network comprising output nodes equal to a number of HOI classes.

15. A human-object interaction (HOI) system comprising a pose detector, a human feature extractor, an object feature extractor, a relation network, and an HOI contextual and reasoning module wherein:
the pose detector is configured for:
receiving a human-crop determined according to boundaries of a human in a human-obj ect proposal;
extracting human pose feature information from the human-crop; and
sending the human pose feature information to the HOI contextual and reasoning module;
the human feature extractor is configured for:
receiving the human-crop;
extracting human appearance feature information from the human-crop; and
sending the human appearance feature information to the HOI contextual and reasoning module;
the object feature extractor is configured for:
receiving an object-crop determined according to boundaries of an object in the human-obj ect proposal;
extracting object appearance feature information from the obj ect-crop; and
sending the object appearance feature information to the HOI contextual and reasoning module;
the relation network is configured for:
receiving a human-object crop determined according to boundaries of the human and the object;
extracting spatial feature information from the human-object crop; and
sending the spatial feature information to the HOI contextual and reasoning module;
the HOI contextual and reasoning module configured for:
receiving the human pose feature information, the human appearance feature information, the object appearance feature information, and the spatial feature information; and
determining whether an HOI exists between the human and the object based on received information.

16. The system of claim 15, wherein the HOI contextual and reasoning module comprises a pose-based human-appearance feature module configured for:
applying a multiplicative operation to the human pose feature information and the human appearance feature information to generate a first pose-based human appearance feature output;
applying, via a first neural network, non-linear transformation to the first pose-based human appearance feature output to generate a second pose-based human appearance feature output;
applying, via a second neural network, non-linear transformation to the human appearance feature information to generate human appearance output;
concatenating the second pose-based human appearance feature output with the human appearance output to generate a third pose-based human appearance feature output; and
applying, via a third neural network, non-linear transformation to the third pose-based human appearance feature output to generate a fourth pose-based human appearance feature output.

17. The system of claim 16, wherein the HOI contextual and reasoning module further comprises a pose-aware spatial encoding module configured for:
applying a multiplicative operation to the human pose feature information and the spatial feature information to generate a first pose-aware spatial feature output;
applying, via a fourth neural network, non-linear transformation to the first pose-aware spatial feature output to generate a second pose-aware spatial feature output;
concatenating the second pose-aware spatial feature output with the spatial feature information to generate a third pose-aware spatial feature output; and
applying, via a fifth neural network, non-linear transformation to the third pose-aware spatial feature output to generate a fourth pose-aware spatial feature output.

18. The system of claim 17 wherein the HOI contextual and reasoning module further comprises a context-aware multi-feature embedding module configured for:
generating a first human local context output based on concatenation of the fourth pose-based human appearance feature output and the fourth pose-aware spatial feature output;
applying, via a sixth neural network, non-linear transformation to the first human local context output to generate a second human local context output;
generating a first human-object global context output based on concatenation of: the fourth pose-based human appearance feature output, the fourth pose-aware spatial feature output, and the object appearance feature information;
applying, via a seventh neural network, non-linear transformation to the first human-object global context output to generate a second human-object global context output;
generating a first object local context output based on concatenation of the fourth pose-aware spatial feature output and the object appearance feature information;
applying, via an eighth neural network, non-linear transformation to the first object local context output to generate a second object local context output;
generating a context aware multi-feature output based on concatenation of: the second human local context output, the second human-object global context output and the second object local context output; and
applying, via a ninth neural network, non-linear transformation to the context aware multi-feature output to generate an indication of the HOI.

19. The system of claim 18, wherein the first, the second, the third, the fourth, the fifth, the sixth, the seventh, and the eighth neural networks are shallow fully connected neural networks.

20. The system of claim 18, wherein the ninth neural network is a dense neural network comprising output nodes equal to a number of HOI classes.
